(19) United States
(12) Patent Application Publication
(10) Pub. No.: US 2009/0319360 A1
(43) Pub. Date: Dec. 24, 2009

(54) Goods/Information Distribution Method by an ATM Terminal Without Using a Debit/Credit Card

(76) Inventor: Roberto Salemi, Udine (IT)

Correspondence Address: SHOEMAKER AND MATTARE, LTD, 10 POST OFFICE ROAD - SUITE 100, SILVER SPRING, MD, 20910, US

(21) Appl. No.: 12/375,050

(22) PCT Filed: Jul. 24, 2006
(86) PCT No.: PCT/IT2006/000563

§ 371 Date: Jan. 26, 2009

(51) Int. Cl. G06Q 30/00; G06F 17/00; G06Q 50/00; G06Q 20/00; G06Q 40/00; G06F 15/16; H04W 4/12

(52) U.S. Cl. 705/14.25; 235/375; 705/14.37; 705/26; 705/34; 705/40; 705/41; 705/43; 709/204; 455/466

(57) ABSTRACT

A goods/information distribution method by ATM terminal (TE1) operationally associated with a plurality of banks is described, said method including steps of:
supplying, on behalf of a bank (B1) of said plurality, an identification code (CDB) to a first mobile communication terminal (TM1) associated with a first user (U1), said code (CDB) being representative of a plurality of attributes (PAT) indicative of the distribution of goods/information;
visualising, on a display with which the first mobile terminal (TM1) is equipped, said identification code (CDB);
placing, on behalf of the first user (U1), said first mobile terminal (TM1) close to an identification code optical reading device (LTC) with which the ATM terminal (TE1) is equipped;
acquiring, on behalf of the ATM terminal (TE1), said identification code;
recognising said identification code;
making said goods/information available to said first user, on behalf of said ATM terminal.

### FIELD OF THE INVENTION

The present invention refers to a goods/information distribution method and, in particular, a goods or information distribution method through the use of ATM (Automated Teller Machine) terminals.

### BACKGROUND OF THE INVENTION

Within the scope of the present information the term “goods/information” herein refers to goods (for example, cash, prepaid card or voucher) and/or information (for example, message on video or on a paper support).

Furthermore, always within the scope of the present description, the term “distribution” refers to either the delivery of cash or prepaid cards, or the printing of a voucher or coupon or the display of a video message.

In English, the generic term Automated Teller Machine ATM terminal identifies the system that allows a user to automatically withdraw cash from his own current account, even outside banking hours and in places other than the bank's branch office where the user has a current account. The automated withdrawal service ATM uses a circuit of interconnected ATM terminals, typically part of a data communication network. In Italy, the automated withdrawal system ATM is best known as Bancomat and ATM terminals are commonly named Bancomat terminals.

The ATM service, Bancomat service in Italy, was born in 1967 and became internationally widespread from 1980. The ATM service was mostly considered, by Financial Institutes, an economic alternative to the branch teller for withdrawals and other low value-added operations, including account balance and statement. Only in recent years have Financial Institutes started to look at ATM terminals as a marketing opportunity and a potential source of income, also thanks to recent technological breakthroughs in this field, capable of having a positive impact on the relationship between the Financial Institute and Customers.

The ATM terminal represents, for Financial Institutes, a tool capable of having a significant impact on the way and extent to which a Customer perceives the value of the services being offered (Customer Experience), taking into consideration all the aspects of the interaction between the user and the Financial Institute itself. The value of such affirmation is amplified if one considers the increase over time of the number of operations performed at ATM terminals in Europe (equal to about 22% in 4 years) and the total value of withdrawals (equal to about 19% in 4 years). Another equally important consideration is the trend regarding the average ATM terminal use frequency. Recent marketing research conducted among the Customers of Financial Institutes shows that 39% of Customers surveyed use an ATM terminal at least once a week.

The ATM service has considerably evolved over the years but it still suffers from inherent characteristics which have made it vulnerable to attacks and frauds from criminals and which have limited its use to cash withdrawal and, in general, transactions strictly linked to the holder of a bank account. In other words, the user who carries out a transaction at an ATM terminal is always and in any case the holder of the bank account on which the transaction itself will be effected.

Furthermore, any activity carried out by a user at an ATM terminal requires the use of a plastic card (debit/credit card) equipped with a magnetic strip which, because it is used numerous times and it lasts several years, is subject to possible demagnetisation and other forms of deterioration, but also cloning.

In this regard, frauds at ATM terminals distributing cash are currently sharply increasing due to the cloning of debit/credit cards, as well as at POS (Point Of Sale), automated machines widespread in Italy and abroad in numerous businesses, through which it is possible, by using a Bancomat-type magnetic card and keying in a PIN (Personal Identification Number), to pay for the goods purchased or services received.

Such frauds are done in various modes, from the simplest to the most sophisticated ones.

In a first case a device is placed on the ATM terminal which, once the user has inserted the card, holds it back so that the cash machine is incapable of giving it back. The user, confused, is not able to complete the transaction being made, nor can he have the card back. At this stage the con man is able to intervene and, pretending to help the user at the ATM terminal, invites him to retype the personal identification number, or simply PIN, thus allowing him to memorise it. Once the victim has gone away, the con man may retrieve the card and use it with the PIN just memorised.

In a second case of fraud, much more widespread and effective than the first one, a user uses the automated teller machine ATM in a normal manner without realising that the data on his card are being copied. In fact, a device placed by the con man in the card insertion slot records the information present on the magnetic strip and a small video camera placed on the control panel of the teller machine films the keying-in of the PIN code. Unfortunately, in some cases, covering the PIN code keying-in step with the hand is not enough, because it is often the mere pressure of the fingers on the keys that sends the exact sequence of the code to a special device, known by the English term skimmer, needed for the cloning of debit/credit cards.

In other cases, the PIN code may be acquired through a fake keyboard placed on top of the cash machine's real and proper one, or it may be intercepted within the ATM terminal itself while transiting from the digital keyboard to the circuit where it will then be encrypted and transmitted for verification. In the latter case, the con man, in order to transfer the card's data and PIN onto a void magnetic card, uses a fake keyboard applied with a rubber band onto the real one, a chip equipped, on the back, with a hidden memory and capable of containing thousands of PIN codes. Before the cheated user notices the fraud, several weeks may go by.

In all the aforementioned cases of fraud, as one may notice, any user in possession of a debit/credit card may be cheated and, what is more serious, in all cases various financial operations may be performed by the con man before the cheated user notices the repeated theft suffered.

Another limitation of ATM terminals currently in use is the lack of prearrangement for use by the disabled.

In this regard, only very recently costly apparatuses equipped with a multimedia solution which allows the use of the ATM service, in total independence, even to the blind users, have been introduced. In this case, the ATM terminal is equipped with special indications in Braille type to identify insertion and card reading devices and banknote delivery devices. This type of ATM terminal is also designed so as to emit acoustic signals and vocal messages to guide the blind user during the entire withdrawal step (card insertion, PIN code keying-in, card withdrawal, banknote and receipt withdrawal). Vocal message guidance may be activated by pushing, on the keyboard, key “5”, identified by a tactile relief. Furthermore, an introduction function is provided, activatable on request, which describes in detail every step of the withdrawal activity, recommended for those who, not yet feeling at ease with the new instrument, wish to have a general overview on its use. Note that access to withdrawal operations is allowed by using normal debit/credit cards. Unfortunately, even this type of ATM terminals, besides being costly, implies a long permanence of the handicapped user in front of the ATM, thus proportionally increasing the risk of being victim of frauds or assaults.

### SUMMARY OF THE INVENTION

The scope of the present invention is to propose a goods or information distribution method by an ATM terminal capable of improving the modes and the quality of the operations performed by a user at an ATM terminal which exceeds, for example, the aforementioned disadvantages of the known methodologies.

Such scope may be attained by the goods/information distribution method by an ATM, Automated Teller Machine, terminal, operationally associated with a plurality of banks, said method including steps of:

supplying, on behalf of a bank of said plurality, an identification code to a first mobile communication terminal associated with a first user, said code being representative of a plurality of attributes indicative of the distribution of goods/information;

visualising, on a display with which the first mobile terminal is equipped, said identification code;

placing, on behalf of the first user, said first mobile terminal close to an identification code optical reading device with which the ATM terminal is equipped;

acquiring, on behalf of the ATM terminal, said identification code;

recognising, at the ATM terminal, said identification code;

making the goods/information available to the first user, on behalf of the ATM terminal.

A network architecture and an ATM terminal are also an object of the present invention.

### BRIEF DESCRIPTION OF THE FIGURES

The invention will be better understood from the following detailed description in an embodiment given for illustrative and non-limiting purposes in reference to the accompanying drawings, in which:

FIG. 1 shows a data communication network architecture according to an example of the invention,

FIG. 2 schematically shows an ATM terminal of the network architecture of FIG. 1,

FIG. 3 shows a flow diagram of a procedure of a method of distribution according to an example of the invention,

FIG. 4 shows a further simplification of the network architecture of FIG. 1, and

FIG. 5 shows a further simplification of the network architecture of FIG. 1.

### DESCRIPTION

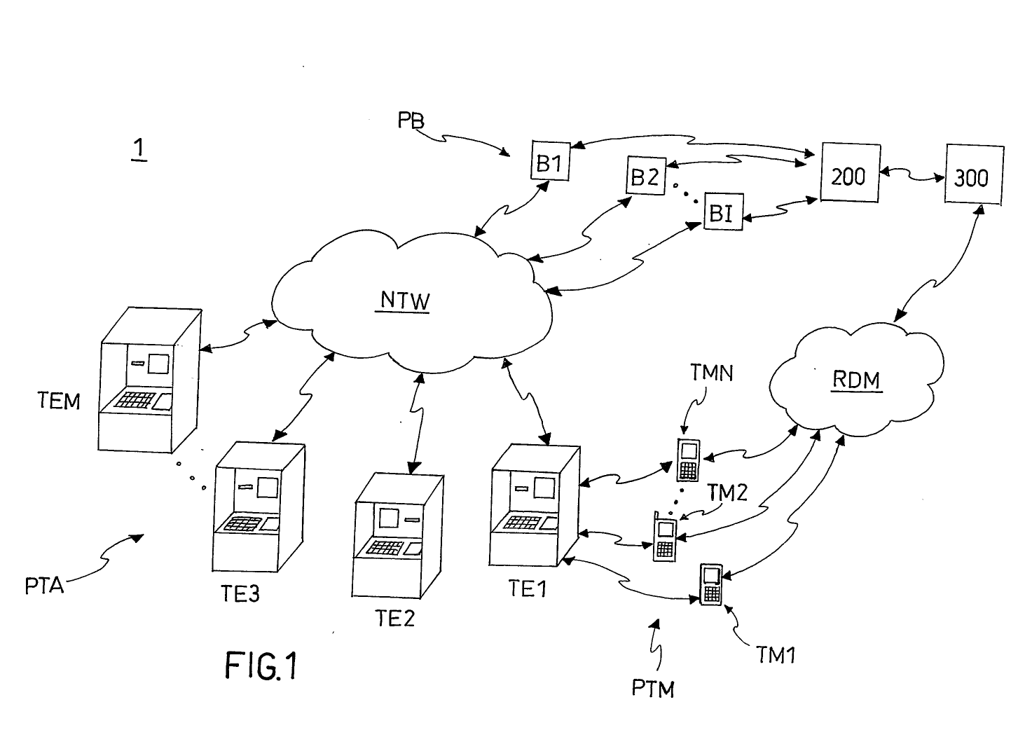

Referring to FIG. 1, a network architecture, generally indicated by reference numeral 1, includes a plurality of ATM terminals PTA (TE1, TE2, TE3, . . . , TEM), each of which is operationally connected, through a data communication network NTW, to a plurality of Banking Institutes, o more simply banks, (B1, B2, . . . , BI), each of which is capable of offering a service of goods/information distribution.

Each Banking Institute is preferably equipped with at least one computer including relative hardware and software for the command and management of banking activities either related to traditional uses of the ATM terminal or according to activities to be executed, on behalf of a Banking Institute, which will be later described in reference to the method examples according to the invention.

Within the scope of the present description, “goods/information” is again to be understood as goods that may be supplied to a user by an ATM terminal such as, for example, cash, prepaid cards, invoices, receipts, marketing communications, coupons and/or displayable information, for example, by the ATM terminal.

The network architecture 1 further includes a plurality of mobile communication terminals PTM, for example cellular phones (TM1, TM2, . . . , TMN), each of which is associable with one or more users and capable of cooperating, as it will be understood in the following, with any one of the ATM terminals.

Each Banking Institute is operationally connected to a validation and control centre 200 also equipped with a least one computer whose respective hardware and software are capable of processing data according to the modes which, also in this case, will be later described.

The validation and control centre 200 is in turn operationally connected to a code dispatch centre 300 which also has at least one computer to carry out the operations it is designed for, whose main ones will be described in the following. The code dispatch centre 300 is capable of sending and possibly receiving messages from the plurality of mobile communication terminals PTM, via a communication network RDM (in the example, a mobile radio network).

The network architecture 1 may also further include various types of terminals (not shown in the figure) through which the user may interact with one of the Banking Institutes of plurality PB. Examples of said terminals are fixed or mobile telephones that may be used by the user to contact a call centre of the Banking Institute. In alternative to the call centre, the user may contact an Interactive Voice Response (IVR) system operationally associated with the same Banking Institute. Another example of a terminal through which the user may communicate with the Banking Institute is a conventional computer (desktop or notebook type) equipped with an Internet connection.

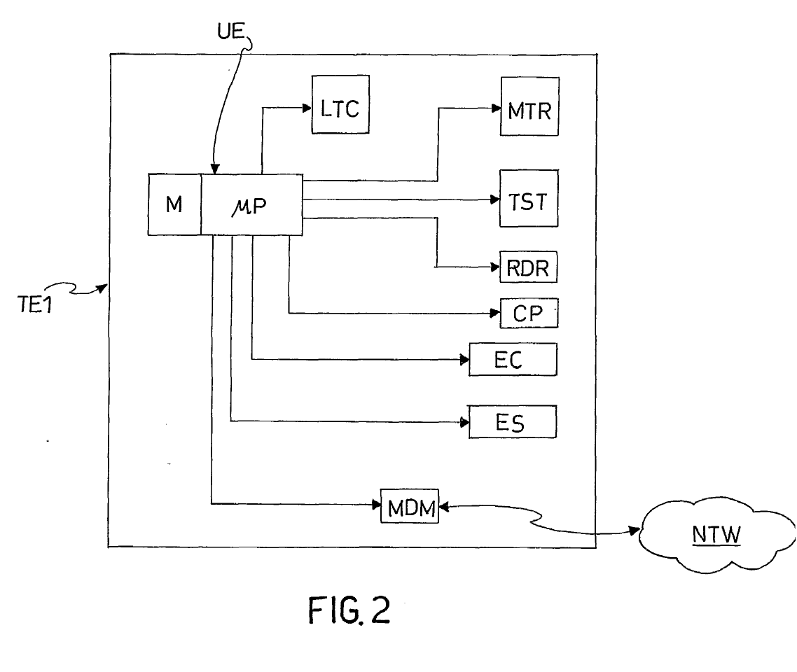

Referring to the scheme of FIG. 2, an ATM terminal of the plurality of terminals PTA, indicated with reference TE1, includes:

a control unit UE equipped with a microprocessor MIC and a memory M, operationally interconnected, capable of loading and carrying out respective program codes for the execution of the operations for which the ATM terminal is designed.

a conventional-type alphanumeric keyboard TST and a monitor MTR, capable of allowing a user to interact with the ATM terminal;

a magnetic strip card reader RDR, itself well known;

a first cash dispenser EC;

a second receipt and coupon dispenser ES;

a prepaid card dispensing basket CP

an identification code reader LTC;

a modem MDM, of a known type, for access, on behalf of the ATM terminal TE1, to the data communication network NTW and connection to each one of the Banking Institutes (B1, B2, . . . , BI) of the plurality of Institutes PB.

From an operational point of view, the identification code reader may be, for example, a bar code reader LTC capable of acquiring and reading by laser scanning or with other optical-type methods a bar code, of a conventional format, placed close to the reader so as to help optical reading.

As known, a bar code includes a series of light and dark regions, typically in rectangular shape, which encode corresponding information. Typically, the width of the dark regions, that is the so-called bars and/or the lengths of the clear spaces between two bars indicate the encoded information.

Within the scope of the method according to the invention, the bar code is preferably contained in a message, preferably of SMS (Short Message Service) type, displayable on a cellular telephone associable with a user. In alternative to the SMS format message, if the user has a last generation cellular telephone or a hand held computer, the bar code may be contained in a multimedia message of MMS (Multimedia Message Service) type or even attachable to the text of an e-mail message.

Note that in the example of the invention the bar code is, advantageously, associated with an alphanumeric character string representative of the same information already encoded by the bar code and to be used in case it is not possible to carry out laser scanning due to an occasional malfunction or lack of a code reading apparatus.

From a hardware point of view, the bar code reader LTC is, preferably, a flat embedded scanner placeable, for example, in horizontal position with respect to a plane of the ATM terminal on which the alphanumeric keyboard TST is placed.

Furthermore, the bar code reader features a metal structure which, advantageously, covers the reading surface preserving it, within reasonable terms, from scratches, dust and acts of vandalism and also eliminating a potential and possible refraction of outside light which may alter the optical reading operation.

Advantageously, the metal structure provides, in its internal part, elastic material padding, for example neoprene, which for its elastic and opaque consistence ensures an essentially optimum optical contact between the flat scanner and the bar code, displayable on a cellular telephone display.

In order to make the intervention of a user absolutely marginal, the external metal structure is equipped on three internal sides with as many sensors capable of activating the lighting of the laser beam of the flat scanner upon insertion of the cellular telephone.

Furthermore, note that an adhesive illustration may be placed close to the flat scanner, advantageously, in order to indicate to the user the correct orientation of the cellular telephone so that the respective display is oriented towards the scanner's reading surface (for example downwards).

Also consider that the bar code reader LTC may be placed outside the room where the ATM terminal is located, in case said room is protected by an entrance door. The bar code reader, installed in this manner, is capable of giving the user access inside the room once the bar code reading on the cellular phone's display has taken place. As it will be reiterated in the following of the present description, such reading is capable of preparing the ATM terminal for a specific operation which the user is about to perform at the terminal itself.

As already mentioned for the bar code reader LTC, when incorporated inside the ATM terminal, even the bar code reader possibly placed on the entrance door of room is operationally connected to the plurality of Banking Institutes PB through the data communication network NTW.

The prepaid card dispensing basket CP includes one or more modules or slots and is placed, for example, inside the ATM terminal resulting divided into numbered compartments and sliding on special servo guides. The dispensing basket CP may be built by assembling the single modules or slots each of which is capable of housing prepaid cards of the same issuing company. Note that, in order to use the distribution of its own prepaid cards, such company stipulates a distribution agreement with one of the Banking Institutes. Anytime a company requiring the distribution of respective prepaid cards is added the dispensing basket is progressively equipped with an extra slot. Consider that from an operational point of view the basket CP is capable of positioning itself, when delivering a prepaid card, in correspondence to a special opening such as, for example, the slot of the card reader RDR already useable, on behalf of the ATM terminal, to receive a debit/credit card.

The implementation of the method of distribution of goods/information according to an example of the invention requires, on behalf of a user, to have permission for a distribution service being offered, for example, by Banking Institutes, Financial Institutes or Telecom Operators.

In case the distribution method example according to the invention consists in dispensing cash, the user provides the aforementioned permission through a subscription that may be taken out with a Banking Institute through various channels, alternative among themselves, such as, for example: a conventional home banking or remote banking service; directly at a bank position with the assistance of dedicated personnel; through an ATM terminal, in self-service mode.

Note that the subscription, which indicates a yearly validity automatically renewable until further notice, may be taken out by the user by preferably indicating a plurality of reference information PIR including, for example: a first mobile telephone number of the subscribing user; a second fixed telephone number of the subscribing user; a list of mobile telephone numbers of benefiting users; password or PIN to access the service of goods/information distribution on behalf of the subscribing user; debit account.

In subscription modes that provides, for example, the use of a telecom operator, the subscribing user may use other further channels, alternative among themselves, such as: the Internet; direct call to a call centre; call to an IVR system; sending an SMS type message with a cellular telephone.

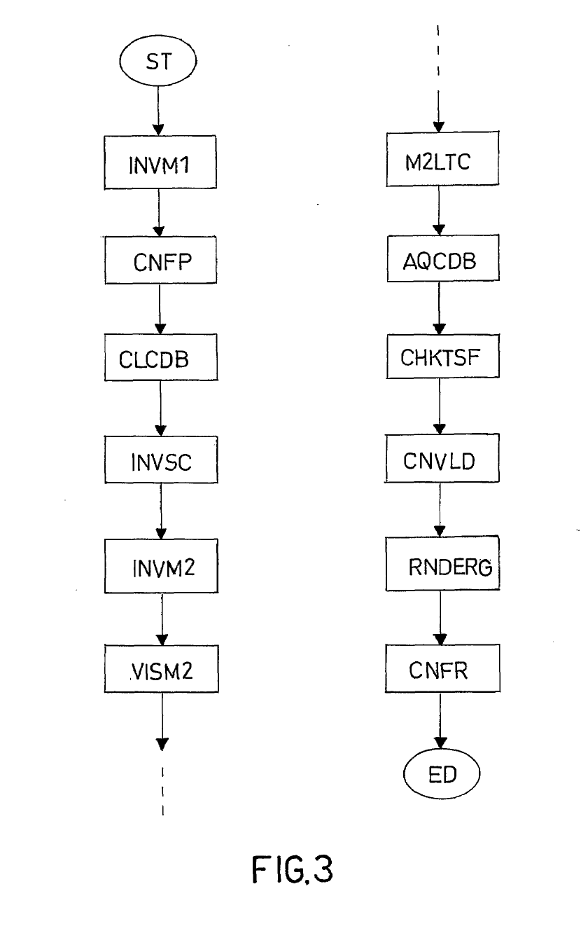

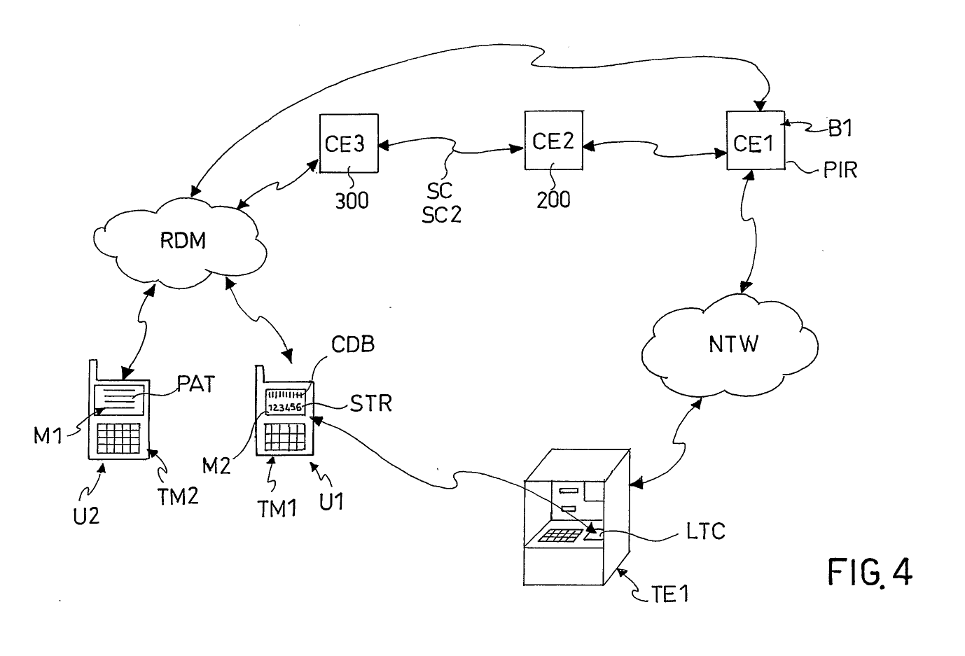

Regarding the method of distribution according to the invention and in reference to FIGS. 3 and 4, now consider the case wherein the distribution takes the shape of a transfer to the first user U1 (benefiting user), equipped with a first mobile communication terminal TM1, for example a first cellular telephone, of cash dispensable from an ATM terminal. The transfer of cash is requested and arranged by a second user U2. In the example described in the following the goods/information is, as may be guessed, cash.

The second user U2, as a user having permission for the service, arranges the transfer of cash (step ST) to the first user U1 by sending a first message M1, in SMS format, from a second mobile or fixed communication terminal TM2 (for example, a second cellular telephone) to a telephone number, preferably a toll-free number or in any case a dedicated number, of a Banking Institute B1 (simply bank in the following) (step INVM1).

Note that the bank B1 called upon by the second user U2 is, reasonably, that where he has a bank current account.

The first message M1 contains a plurality of attributes PAT indicative of the cash transfer data requested by the second user U2.

In particular, the plurality of attributes PAT includes, for example, the following information:

mobile telephone number of the first user U1;

an amount of cash to be transferred;

a first indication representative of the time validity (limit date) during which the first user U1 may withdraw, at the ATM terminal TE1, the cash;

a second indication representative of the geographic restriction on the presence of the ATM terminal TE1 which the first user U1 may reach for the withdrawal of cash; the geographic restriction may be expressed in terms of a region, province or city within which the first user U1 may look for the nearest ATM terminal;

a third indication indicative of possible banking restrictions on the transfer of cash, for example and in relation to Italy, the ABI and CAB codes, themselves known.

password or secret question to permit withdrawal by the first user; this scheme allows to increase the safety of the cash transfer operation.

Note that the transmission of the plurality of attributes PAT to the bank B1 may also take place through communication channels other than by sending a simple SMS. For example, the second user U2 may contact the call centre associated with the bank B1 and indicate the plurality of attributes PAT to an operator. Alternatively, the plurality of attributes PAT may be provided to an IVR system which collects the data and forwards it to the bank B1. If provided for, the second user U2 may communicate the plurality of attributes PAT to the bank B1 by filling in special fields of a web page inserted within the home or remote banking service of the bank B1.

The bank B1, through a first computer CE1, compares (step CNFP) said plurality of attributes PAT with the plurality of reference information PIR which, as previously mentioned, is supplied by a second user U2 when subscribing to the cash transfer service.

In particular, the bank B1 controls, for example, the accuracy of the data (second user U2 regularly subscribing to the service, first user U1 possibly found in the list of coordinates) and the feasibility of transferring cash (availability of the current account of the second user U2 to dispense the amount of cash indicated).

The plurality of attributes PAT, confirmed by the bank B1 through the secret password, reaches the validation and control centre 200 which, through a second computer CE2, calculates, from the plurality of attributes PAT, a bar code CDB and a character string STR (step CLCDB). Within the bar code CDB (and in the string STR) the data of the requested transfer of cash are encoded.

The second computer CE2 may be programmed to calculate, in alternative to the bar code CDB and the string STR, other identification codes such as, for example, two-dimensional codes. Note that, in general, it is necessary for the identification code being used (two-dimensional or of any other format) to be sendable through an SMS format message and recognisable by the reader with which the ATM terminal TE1 may be equipped.

The validation and control centre 200 sends to the code dispatch centre 300 an activation signal SC to which the calculated bar code CDB and the coordinate of the first user U1 are attached (step INVSC). A third computer CE3, associated with the dispatch centre 300, after receiving the activation signal SC, is activated for the dispatch requested by the authorisation centre 200 and sends a second message M2, in SMS format, including the bar code CDB and the string SMS, to the first cellular telephone TM1 associated with the first user U1 (step INVM2).

The first user U1 receives on the first cellular telephone TM1 the second message M2 and visualises it on a display with which the first cellular telephone TM1 is equipped (step VISM2). Note that, within the scope of the method example according to the invention which is being described, the bar code is adapted, by the dispatch centre 300, to the dimensions of the display of the first cellular telephone TM1, through a preventive procedure of spontaneous recognition and indication on behalf of the first user U1 or the second user U2. Further note that, as already previously anticipated, the second message M2 may also be in a format other than SMS such as, for example, the MMS format. In this case, it is necessary for the first user U1 to have a cellular telephone capable of receiving messages in MMS format.

After visualising the second message M2, the first user U1 proceeds, within reasonable time, to the ATM terminal TE1 which is, reasonably, closest to him upon reception of the second message M2 and in any case possibly compatible with possible geographic (region, province, city) and banking (ABI and CAB in Italy) restrictions possibly imposed by the second user U2. In this regard, note that, possibly, the code dispatch centre 300 may send to the first user U1, following the second message M2, a map visualisable on the first cellular telephone TM1 (if preset) to help him reach the closest ATM terminal.

After reaching the ATM terminal TE1, the first user U1 places the display of the first cellular telephone TM1 close to the flat scanner LTC (step M2LTC).

Note that in the particular case in which the ATM terminal TE1 is inside room, the first user U1 places the display of the first cellular telephone TM1 close to a further flat scanner possibly located close to the access door to said room.

Further note that, advantageously, in the event of an unsuccessful reading through laser scanning, the first user U1 may provide the information encoded in the bar code CDB by keying in, with the alphanumeric keyboard TST of the ATM terminal TE1, the alphanumeric string STR.

Going back however to the example described, the validation and control centre 200, through the data communication network NTW and the bank B1, acquires from the scanner of the ATM terminal TE1 the bar code CDB (step AQCDB) and verifies, through the second computer CE2, if the transfer requested, and the resulting cash delivery, are in effect feasible at that specific ATM terminal (step CHKTSF).

Upon completion of this first control, the validation and control centre 200 invites the first user U1 to confirm the transfer of cash, at the ATM terminal TE1, by keying in the safety password or by answering a question to give evidence of having proceeded to the ATM terminal TE1 as the user benefiting from the transfer of cash corresponding to the bar code (step CNVLD).

Following the confirmation step, the validation and control centre 200 makes the delivery of cash available, on behalf of the ATM terminal TE1, which may then be withdrawn by the first user U1 (step RNDERG).

Note that concurrently to making the delivery of cash available, the validation and control centre 200 sends, through a second computer CE2, a further activation signal SC2 to the dispatch centre 300 which will be activated again to send a third message M3 in SMS format to confirm to the second user U2, as transferring user, the successful transfer and delivery of cash in favour of the first user U1 (step CNFR).

The block diagram of FIG. 3 ends with a symbolic end step indicated by initials ED.

Note that the second user U2 may request a transfer of cash to his benefit by simply indicating in the first message M1, as the mobile telephone of the benefiting user, his own cellular telephone number. The second user U2 will then receive on the second cellular telephone TM2 the second message M2 with which to proceed to the closest ATM terminal and withdraw the amount of cash requested.

Still regarding the transfer of cash from the second user U2 to the first user U1, note that it is possible, for the second user U2, to indicate in the first message M1 further restrictive conditions so as to make the amount of cash withdrawable, by the first user U1, in several distinct portions. The first user U1 will have the possibility, in alternative, to withdraw only a part of the amount received from the second user U2 depositing the balance on his own current account appropriately indicated through a procedure which the same first user is capable of executing at the ATM terminal.

A second distribution method example according to the present invention regards the delivery, with regard to the first user U1, on behalf of the ATM terminal TE1, of prepaid cards such as for example, prepaid phone cards, prepaid TV subscription cards, prepaid credit cards and the like. The goods, in this case, are the prepaid card. Note that one or more companies owning services that may be taken advantage of by acquiring prepaid cards stipulate an agreement with the plurality of Banking Institutes PB to have the cards distributed through the plurality of ATM terminals PTA.

Even in this example, by analogy to the transfer of cash, the delivery of a prepaid card takes place upon request by the second user U2.

As already previously described, it is required, on behalf of the second user U2, to have permission for a service of prepaid card delivery whose subscription modes and possible alternatives are analogous to those already previously described.

Regarding the plurality of reference information PIR, besides the information analogous to that already mentioned in the method example previously described, several extra attributes are provided such as, for example:

user code or name of the benefiting user;

prepaid telephone use;

prepaid debit cards.

The second user U2 arranges for the delivery of a prepaid card (for example, a prepaid phone card) to the first user U1 by sending the first message M1, in SMS format, from the second cellular telephone TM2 to the bank B1 and then to the authorisation and control centre 200.

The first message M1 includes a plurality of characteristics PAC capable of indicating the data of the prepaid card delivery operation and which may be provided to the validation and control centre 200, analogously to the plurality of attributes PAT, according to the various forwarding modes, alternative among themselves, already previously described.

The plurality of characteristics PAC includes, preferably, information regarding:

a company issuing the prepaid card;

a refill amount or its denomination;

a user code or the name of the first user U1;

the limit date of validity by which the first user may withdraw, at the ATM terminal TE, the prepaid card being delivered;

possible geographic restrictions on delivery such as, for example, the region, the province or the city;

possible banking restrictions on the card delivery that may be indicated by using the ABI and CAB codes, for Italy;

keyword or secret question to guarantee the safety of the prepaid card delivery operation.

Note that it is possible for the second user U2 to indicate, in the plurality of characteristics PAC, his own mobile telephone number and to be therefore recognised as the beneficiary of the prepaid card delivery.

The second method example further includes all the steps already previously described in illustrating the first method example regarding the transfer of cash.

In a third method example according to the present invention the distribution of goods/information takes shape instead in the visualisation on the monitor MTR of the ATM terminal TE of a customised promotional message MPP or spot inherent to the profile of the first user U1. The goods/information is therefore the customised promotional message MPP as information.

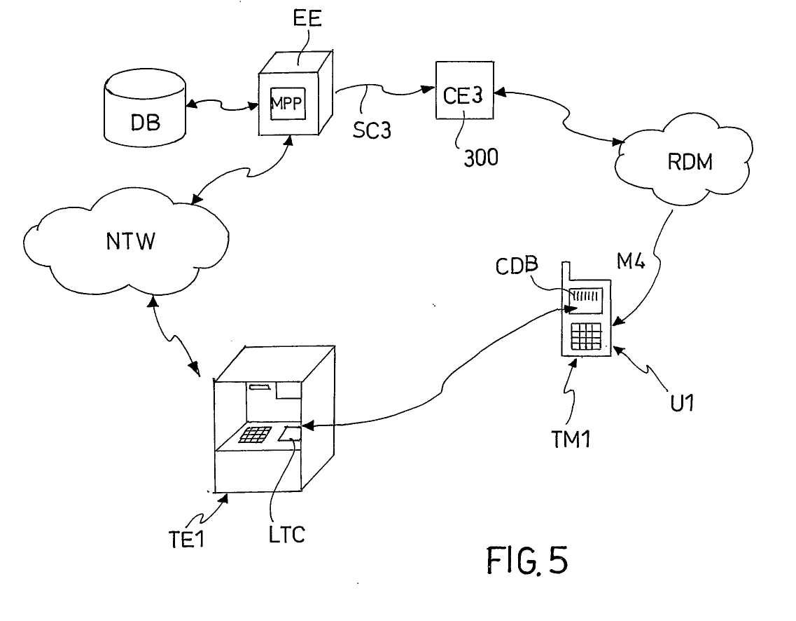

Referring to the scheme of FIG. 5, note that, unlike the examples previously described, the arrangement for the visualisation of the advertising message takes place upon request by a database DB operationally associated with a computer EE.

The database DB contains profiling information regarding many users, each of whom is registered therein, so that it is possible for the computer EE to trace back the preferences and tastes of a particular user and create ad hoc the customised promotional message MPP corresponding as much as possible to the interests of a user.

In particular, the computer EE, after consulting, in the database DB, the profiling information inherent, for example, to the first user U1, chooses the customised promotional message MPP which best corresponds to the profile of the first user U1.

Then, the computer EE calculates, as a result, the bar code CDB in which both the information necessary for the visualisation, at the ATM terminal TE1, of the customised promotional message MPP and the promotional message MPP itself are encoded.

The third method example, according to the invention, therefore provides the steps already described in the previous examples such as:

sending, on behalf of the computer EE, a third activation signal SC3 to the code dispatch centre 300;

sending, on behalf of the dispatch centre 300, a fourth SMS-type message M4, containing the bar code, to the first cellular telephone of the first user U1;

visualisation, on behalf of the first user U1, of the message on the display of the first cellular telephone.

At this stage, the first user U1, when proceeding to the ATM terminal TE1 (possibly indicated), places the display of the first cellular telephone close to the bar code reader LTC allowing the processing unit UE to visualise, on the monitor MTR of the terminal TE1, the customised promotional message MPP.

Note that, advantageously, the ATM terminal TE1 may offer the first user U1 the possibility of choosing to visualise or not the promotional message MPP.

Furthermore, the first user U1, advantageously, has the possibility of requesting, at the ATM terminal, to send further information regarding the promotional message to a terminal of his choice (for example, cellular telephone, hand held computer or personal computer through e-mail messages, instant messenger and analogous programs) or requesting, to the receipt dispenser with which the ATM terminal is equipped, the printing of a coupon.

Note that the coupon may contain a remind of the promotional message or, advantageously, a further bar code usable by the first user U1 to obtain a discount at a sales outlet, presumably close to the ATM terminal, associated with the promotional message.

Further note that, advantageously, the bar code printed on the coupon may be representative of the successful prepayment, on behalf of the user U1, for an item object of the promotional message. In particular, the first user U1, considering advantageous, for example, an offer associated with the item proposed by the promotional message, may directly charge on his own bank account, while taking advantage or not of discounts provided by that offer, the purchase amount of such item at a sales outlet. At the end of this prepayment operation, the processing unit UE of the ATM terminal TE1 generates a payment bar code which is printed on a coupon dispensed by the ATM terminal TE and, concurrently, issues a payment password valid for a single operation and associable with the printed coupon already containing the payment bar code.

The payment password is sent, respectively through the bank B1, the validation centre 200 and the dispatch centre 300, to the first cellular telephone TM1 associated with the first user U1. At this stage, the first user U1 proceeds to the sales outlet, exhibits the printed coupon and keys in the payment keyword to confirm, upon purchasing the goods, the transfer of the amount to the merchant.

In a fourth example of embodiment, the fourth message M4 may be sent to the first user U1 on request by a utility company (for example a telephone operator or an electric power supplier) and may contain an invoicing bar code representative of the data regarding the issue, on behalf of said utility company, of a new invoice with regard to the first user U1. The latter, after visualising the fourth message M4 on the first cellular telephone, proceeds to the ATM terminal TE1 and places the display close to the code reader LTC to help the laser scanning of the invoicing bar code. Following this action, the invoice number, amount and due date, for example, may be visualised on the monitor MTR of the ATM terminal. At this stage the first user U1, through the keyboard TST and by following the indications that appear on the monitor, has the possibility to: carry out the payment of the invoice by inserting, for example, the data of his own account; insert a remind to visualise on his own terminal (SMS on the telephone, e-mail on a notebook or hand held computer) to remember the next due date (for example in 15 days); printing the invoice possibly just paid directly from the ATM terminal TE1. For such operation, note that the ATM terminal TE1 may be equipped with a further printer, not shown in the figures, preferably of high-speed laser type and capable of issuing printed sheets in A4 format.

The functionality of printing from an ATM terminal is very advantageous for users who do not have an Internet connection and the possibility of receiving a fiscal document (invoice) in electronic format.

The same printing functionality may also be used for more bulky promotional material which a user, after receiving the corresponding SMS, finds impossible to receive and print with a conventional terminal of his own. The reception and printing of promotional material at an ATM terminal do not require, advantageously, postage and particularly long delivery times. Furthermore, visualising a promotional message and obtaining a complete report on the successful use of the message itself (place, mode, timing) is guaranteed in a useful manner.

As may be noted the scope of the invention is fully attained as the goods/information distribution method examples described, besides the advantages already mentioned, allow to significantly reduce the drawbacks of the known art.

In particular, in case a user wishes to carry out a withdrawal from an ATM terminal, it is enough for him to send an SMS-type message to his own bank to receive on his own cellular telephone a corresponding message comprising a code to use for the withdrawal. The withdrawal mode described requires a reading of the code through laser scanning and the following delivery of cash. Note that the user is not required to insert, inside the ATM terminal, any debit/credit card and this minimises the possibility, on behalf of a criminal, of cloning said card with traditional intrusive methods.

Furthermore, the fact that the message received by the user has a limited geographic and time validity and that withdrawal is permitted only after inserting a password significantly reduces the possibility, for a criminal, of using the same message in case he manages to take hold by force of the benefiting user's cellular telephone.

Another advantage is represented by the optical reading of the identification code of the transfer of cash as it allows to significantly limit the permanence of a user (even disabled) at the ATM terminal thus reducing the possibility of being victim of assault by an ill-intentioned individual.

Furthermore, the method according to the invention allows the use of the ATM terminal even to people who are usually not at ease with technology such as, for example, the elderly and the disabled, but who simply own a cellular telephone.

Moreover, the method according to the invention allows a father to make a gift to his son (not in possession of a withdrawal card) either through the transfer of cash (typical weekly pocket money) or through the visualisation of a personalised promotional message and the following printing of a purchase discount coupon.

1. A goods/information distribution method by an ATM, Automated Teller Machine, terminal (TE1) operationally associated with a plurality of banks (PB), said method including steps of:
supplying (INVM1, CNFP, CLCDB, INVSC, INVM2), on behalf of a bank (B1) of said plurality (PB), an identification code (CDB) to a first mobile communication terminal (TM1) associated with a first user (U1), said code (CDB) being representative of a plurality of attributes (PAT) indicative of the distribution of goods/information;
visualizing (VISM2), on a display with which the first mobile terminal (TM1) is equipped, said identification code (CDB);
placing (M2LTC), on behalf of the first user (U1), said first mobile terminal (TM1) close to an identification code optical reading device (LTC) with which the ATM terminal (TE1) is equipped;
acquiring (AQCDB), on behalf of the ATM terminal (TE1), said identification code;
recognizing (CHKTSF), at the ATM terminal (TE1) said identification code;
making the goods/information available (RNDERG) to the first user, on behalf of the ATM terminal.

2. A distribution method according to claim 1, wherein the step of supplying the identification code includes the step of supplying (INVM1), on behalf of a second user (U2) and through a second communication terminal, a first message (M1), including said plurality of attributes (PAT), to the bank (B1).

3. A distribution method according to claim 2, wherein the step of supplying the identification code further includes the step of comparing (CNFP), on behalf of a first computer associated with the bank (B1), at least a part of the plurality of attributes (PAT) with a plurality of reference information (PIR) stored in the bank (B1).

4. A distribution method according to claim 3, wherein the step of supplying the identification code further includes the step of supplying, on behalf of the bank (B1), said plurality of attributes (PAT) to a validation and control center (200), operationally connected to said bank (B1), when at least said part of said plurality of attributes corresponds to said plurality of reference information.

5. A distribution method according to claim 4, wherein the step of supplying the identification code further includes the step of calculating (CLCDB), on behalf of a second computer (CE2) with which the validation and control center is equipped, said identification code (CDB) based on said plurality of attributes (PAT).

6. A distribution method according to claim 5, wherein the step of supplying the identification code further includes the step of sending (INVSC), on behalf of the validation and control center (200), an activation signal (SC) to an identification code dispatch center (300) operationally connected to said validation and control center (200), said activation signal having attached therewith said identification code (CDB) and a telephone number associated with the first mobile communication terminal (TM1).

7. A distribution method according to claim 6, wherein the step of supplying the identification code further includes the step of dispatching (INVM2), on behalf of a third computer (CE3) with which the dispatch center (300) is equipped, after receiving said activation signal (SC), a second message (M2), including said identification code (CDB), to the first mobile communication terminal (TM1).

8. A distribution method according to claim 7, wherein the second message (M2) further includes an alphanumeric character string (STR) associable with said identification code (CDB).

9. A distribution method according to claim 8, wherein the step of visualizing (VISM2) said identification code includes the step of visualizing, on behalf of the first user (U1) said second message (M2) on the display of the first mobile communication terminal (TM1).

10. A distribution method according to claim 9, wherein the step of placing (M2LTC) said first mobile communication terminal (TM1) close to the reading device (LTC) includes a step of acquiring (AQCDB), on behalf of the second computer (CE2), said identification code (CDB).

11. A distribution method according to claim 10, wherein the step of recognizing (CHKTSF) said identification code (CDB) further includes a step of comparing, on behalf of the second computer (CE2), the plurality of attributes (PAT) extractable by said identification code with the plurality of reference information (PIR).

12. A distribution method according to claim 11, wherein the step of making said goods/information available (RNDERG) includes a step of confirming (CNVLD), on behalf of the first user (U1), the distribution of the goods/information.

13. A distribution method according to claim 12, wherein the step of confirming (CNVLD) includes a step of supplying, to the second computer (CE2), evidence capable of demonstrating that said first user (U1) is the beneficiary of the goods/information.

14. A distribution method according to claim 2, further including the step of confirming (CNFR) to the second user (U2), on behalf of the second computer (CE2), the provided availability, on behalf of the ATM terminal (TE1), of the goods/information.

15. A distribution method according to claim 14, wherein the step of confirming (CNFR) includes a step of sending, on behalf of the dispatch center (300), a third message (M3), on request by the second computer (CE2), to the second user (U2) including information representative of the provided availability of the goods/information.

16. A distribution method according to claim 15, wherein the second message (M2) is of SMS type, the first mobile communication terminal (TM1) is a first cellular telephone, said step of dispatching (INVM2) said second message using a communication network of mobile radio type (RDM).

17. A distribution method according to claim 16, wherein the third message (M3) is of SMS type and the second mobile communication terminal (TM2) is of mobile type, said step of sending the third message (M3) using the mobile radio network (RDM).

18. A distribution method according to claim 17, wherein the first message (M1) is of SMS type and the second communication terminal (TM2) is of mobile type, said step of supplying the first message (M1) using the mobile radio network.

19. A distribution method according to claim 1, wherein the step of supplying the identification code (CDB) includes a step of supplying said plurality of attributes (PAT) to the bank (B1) by calling, on behalf of the second user (U2), a call center.

20. A distribution method according to claim 1, wherein the step of supplying the identification code (CDB) includes a step of supplying said plurality of attributes (PAT) to the bank (B1) by calling, on behalf of the second user (U2), an IVR system.

21. A distribution method according to claim 1, wherein the step of supplying the identification code (CDB) includes a step of supplying said plurality of attributes (PAT) to the bank (B1) by filling in special fields of a web page of a home/remote banking service associated with said bank (B1).

22. A distribution method according to claim 2, further including a step of obtaining, on behalf of the second user (U2), permission for a service of goods/information distribution.

23. A distribution method according to claim 22, wherein the step of obtaining permission includes a step of taking out the subscription to a distribution service.

24. A distribution method according to claim 23, wherein the step of taking out the subscription is feasible in a mode belonging to the following group: subscription through home banking, subscription through remote banking, subscription through ATM terminal, subscription through an operator of a bank teller.

25. A distribution method according to claim 24, wherein the step of taking out the subscription includes a step of supplying to the bank (1) said plurality of reference information (PIR).

26. A distribution method according to claim 25, wherein said plurality of reference information (PIR) includes:
a first mobile telephone number of the second user (U2);
a second fixed telephone number of the second user;
a list of mobile telephone numbers of benefitting users;
password to access the service of goods/information distribution on behalf of the second user (U2);
debit account.

27. A distribution method according to claim 1, wherein the goods/information is cash.

28. A distribution method according to claim 27, wherein said plurality of attributes (PAT) includes:
mobile telephone number of the first user (U1);
an amount of cash;
a first indication representative of the time validity of the cash distribution at the ATM terminal (TE1);
a second indication representative of the geographic restriction on the presence of the ATM terminal (TE1);
a third indication indicative of banking restrictions on the distribution of cash;
password or secret question to permit the withdrawal by the first user (U1).

29. A distribution method according to claim 1, wherein the goods/information is a prepaid card.

30. A distribution method according to claim 1, wherein the goods/information is a customized promotional message (MPP).

31. A distribution method according to claim 30, wherein the step of supplying the identification code (CDB) to the first user (U1) takes place on behalf of a computer (EE) operationally associated with a database (DB) including the profiling data of a plurality of users.

32. A distribution method according to claim 31, further including the step of choosing, on behalf of the computer (EE), the customized promotional message (MPP) based on a profile of the first user (U1) contained in the database (DB).

33. A distribution method according to claim 30, wherein the step of making the goods/information available includes the step of visualizing said promotional message (MPP) on a monitor with which the ATM terminal (TE1) is equipped.

34. A distribution method according to claim 33, further including the step of printing from the ATM terminal (TE1), on behalf of the first user (U1), a coupon associated with said customized promotional message (MPP) and representative of a discount coupon on the purchase, at a sales outlet, of an item object of said message.

35. A distribution method according to claim 34, wherein said coupon includes a payment code of said item, said payment code being calculated and supplied to the ATM terminal (TE1) by the bank (B1).

36. A distribution method according to claim 35, further including the step of sending, on behalf of the dispatch center (300), a prepayment password to associate with the payment code.

37. A distribution method according to claim 36, including the step of acquiring said item, on behalf of the first user (U1), by exhibiting and using, at the sales outlet, the payment code and the prepayment password to transfer to the sales outlet an amount prepaid by the first user (U1) for the purchase of the item.

38. A distribution method according to claim 1, wherein the goods/information is a payment invoice notice.

39. A distribution method according to claim 38, wherein the identification code is supplied by a utility company for the issue of the payment invoice issued to the first user (U1).

40. A distribution method according to claim 39, wherein the identification code (CDB) is associated with a fourth message (M4) of SMS type and sent to the first mobile communication terminal (TM1) through a mobile radio network.

41. A distribution method according to claim 40, wherein the step of making the goods/information available (RNDERG) includes the step of visualizing said payment invoice notice on the monitor with which the ATM terminal (TE1) is equipped.

42. A distribution method according to claim 41, wherein the step of making said goods/information available further includes the step of paying, on behalf of the first user (U1), the invoice.

43. A distribution method according to claim 41, wherein the step of making the goods/information available further includes the step of inserting, on behalf of the first user (U1), on the ATM terminal (TE1), a remind to visualize on a further terminal with which the first user is equipped.

44. A distribution method according to claim 41, wherein the step of making the goods/information available further includes the step of printing, on behalf of the first user (U1), the invoice paid through a printer with which the ATM terminal (TE1) is equipped.

45. A distribution method according to claim 1, wherein said identification code (CDB) is a bar code.

46. A distribution method according to claim 1, wherein said identification code (CDB) is a two-dimensional code.

47. A distribution method according to claim 27, wherein the step of supplying the identification code includes the step of supplying to the bank (B1), on behalf of the first user (U1), a respective message including said plurality of attributes (PAT).

48. A network architecture (1) of goods/information distribution including:
at least one ATM, Automated Teller Machine, terminal (TE1), equipped with a code reading optical device (LTC);
at least one first mobile communication terminal (TM1) equipped with a visualization display;
a plurality of banks (PB) operationally connected, through a communication network (NTW, RDM), to said at least one first mobile communication terminal (TM1) and to at least one ATM terminal (TE1);
said architecture being characterized by being configured to execute the steps of the distribution method of claim 1.

49. An ATM terminal including:
an optical reading device (LTC) for the acquisition of identification codes;
a control unit (UE) connected to the reading device (LTC) of an identification code representative of a plurality of attributes (PAT) indicative of a goods/information distribution;
at least one goods/information delivery device capable of distributing the goods/information under the control of the control unit following the recognition of said identification code.
